(19) United States
(12) Patent Application Publication
(10) Pub. No.: US 2023/0081719 A1
(43) Pub. Date: Mar. 16, 2023

(54) MODEL MANAGEMENT DEVICE AND MODEL MANAGEMENT METHOD

(71) Applicant: TOYOTA JIDOSHA KABUSHIKI KAISHA, Toyota-shi Aichi-Ken (JP)

(72) Inventors: Daiki Yokoyama, Gotemba-shi Shizuoka-ken (JP); Tomohiro Kaneko, Mishima-shi Shizuoka-ken (JP)

(73) Assignee: TOYOTA JIDOSHA KABUSHIKI KAISHA, Toyota-shi Aichi-ken (JP)

(21) Appl. No.: 17/893,671

(22) Filed: Aug. 23, 2022

(30) Foreign Application Priority Data
Sep. 15, 2021 (JP) 2021-150592

(51) Int. Cl. G06N 3/08; G06N 3/04

(52) U.S. Cl. CPC G06N 3/08; G06N 3/0454

(57) ABSTRACT

A model management device includes a communication execution unit that transmits, when a first machine learning model having an accuracy of a predetermined value or more is generated in a first target area, information about the first machine learning model to at least one target area different from the first target area.

### CROSS-REFERENCE TO RELATED APPLICATION

This application claims priority to Japanese Patent Application No. 2021-150592 filed on Sep. 15, 2021, incorporated herein by reference in its entirety.

### BACKGROUND

### 1. Technical Field

The present disclosure relates to a model management device and a model management method.

### 2. Description of Related Art

Japanese Unexamined Patent Application Publication No. 2013-069084 (JP 2013-069084 A) describes collecting data from a plurality of business entities in a smart city. In order to make people's lives more comfortable using information and communication technology, it is desirable to be able to make effective use of such big data.

For example, it is conceivable to generate a machine learning model capable of outputting a desired predicted value by using a large number of data acquired in a predetermined target area such as a smart city.

### SUMMARY

In areas where people reside, common problems often arise despite regional differences. Therefore, even when a plurality of target areas is developed separately, a machine learning model having similar prediction targets is likely to be used in each of the target areas. In this case, it is desirable to be able to share knowledge among different target areas and reduce the burden for improving the accuracy of the machine learning model.

In view of the above problems, an object of the present disclosure is to efficiently improve the accuracy of the machine learning model when the machine learning model is used in a plurality of target areas.

The gist of the present disclosure is as follows.

(1) A model management device includes a communication execution unit that transmits, when a first machine learning model having an accuracy of a predetermined value or more is generated in a first target area, information about the first machine learning model to at least one target area different from the first target area.

(2) In the model management device according to (1) above, the at least one target area includes a second target area, and in a case where the communication execution unit receives a result that an accuracy of the first machine learning model is not improved with respect to an existing machine learning model in the second target area when data acquired in the second target area is used, the communication execution unit stops transmitting the information about the first machine learning model to remaining target areas.

(3) In the model management device according to (1) or (2) above, the at least one target area includes a second target area, and in a case where the communication execution unit receives a result that an accuracy of the first machine learning model is not improved with respect to an existing machine learning model in the second target area when data acquired in the second target area is used, the communication execution unit transfers the result to the at least one target area other than the second target area.

(4) In the model management device according to any one of (1) to (3) above, the first machine learning model is generated using a different kind of a machine learning model from an existing machine learning model in the first target area.

(5) The model management device according to (1) above further includes a model selection unit that is installed in the first target area and that selects a machine learning model to be used in the first target area. The first machine learning model is generated using a different kind of a machine learning model from an existing machine learning model in the first target area. When data acquired in each target area is used and an accuracy of the first machine learning model is improved with respect to an existing machine learning model in each target area in a predetermined number or more of target areas other than the first target area, the model selection unit changes the machine learning model to be used in the first target area to the first machine learning model.

(6) A model management device is a model management device installed in a second target area different from a first target area. The model management device includes a communication execution unit that receives information about a first machine learning model when the first machine learning model having an accuracy of a predetermined value or more is generated in the first target area.

(7) The model management device according to (6) above further includes a learning unit for relearning the first machine learning model using data acquired in the second target area.

(8) The model management device according to (6) or (7) above further includes: a model selection unit that selects a machine learning model to be used in the second target area; and an accuracy calculation unit that calculates the accuracy of the first machine learning model using data acquired in the second target area. When the accuracy of the first machine learning model calculated by the accuracy calculation unit is higher than an accuracy of an existing machine learning model in the second target area, the model selection unit changes the machine learning model to be used in the second target area to the first machine learning model.

(9) The model management device according to (6) or (7) above further includes: a model selection unit that selects a machine learning model to be used in the second target area; and an accuracy calculation unit that calculates the accuracy of the first machine learning model using data acquired in the second target area. In a case where the accuracy of the first machine learning model calculated by the accuracy calculation unit is higher than an accuracy of an existing machine learning model in the second target area, and the accuracy of the first machine learning model is improved with respect to an existing machine learning model in each target area when data acquired in each target area is used in a predetermined number or more of target areas other than the second target area, the model selection unit changes the machine learning model to be used in the second target area to the first machine learning model.

(10) In the model management device according to (8) or (9) above, when the accuracy of the first machine learning model calculated by the accuracy calculation unit is equal to or less than the accuracy of the existing machine learning model in the second target area, the communication execution unit transmits a result to the first target area.

(11) In the model management device according to (5) or (9) above, the predetermined number differs depending on an output parameter of a machine learning model to be changed.

(12) In the model management device according to (11) above, when the output parameter is data related to human health, the predetermined number is increased as compared with a case where the output parameter is other than the data related to human health.

(13) A model management method includes transmitting, when a first machine learning model having an accuracy of a predetermined value or more is generated in a first target area, information about the first machine learning model to at least one target area different from the first target area.

According to the present disclosure, when the machine learning model is used in a plurality of target areas, the accuracy of the machine learning model can be efficiently improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a plurality of AI devices installed in a plurality of target areas;

FIG. 2 is a diagram schematically showing the configuration of the AI device of FIG. 1;

FIG. 3 is a functional block diagram of a processor of the AI device;

FIG. 4 is a flowchart showing a control routine of a normal learning process according to a first embodiment;

FIG. 5 is a flowchart showing a control routine of an accuracy improving process according to the first embodiment;

FIG. 6 is a flowchart showing a control routine of a model information receiving process according to the first embodiment;

FIG. 7 is a flowchart showing a control routine of an accuracy result receiving process according to the first embodiment;

FIG. 8 is a flowchart showing a control routine of an accuracy improving process according to a second embodiment;

FIG. 9 is a flowchart showing a control routine of a model information receiving process according to the second embodiment;

FIG. 10 is a flowchart showing a control routine of an accuracy result receiving process according to the second embodiment;

FIG. 11 is a diagram schematically showing a plurality of AI devices installed in a plurality of target areas and a management server;

FIG. 12 is a diagram schematically showing the configuration of the management server of FIG. 11; and

FIG. 13 is a functional block diagram of a processor of the management server.

### DETAILED DESCRIPTION OF EMBODIMENTS

Hereinafter, embodiments of the present disclosure will be described in detail with reference to the drawings. In the following description, similar components are given the same reference numbers.

### First Embodiment

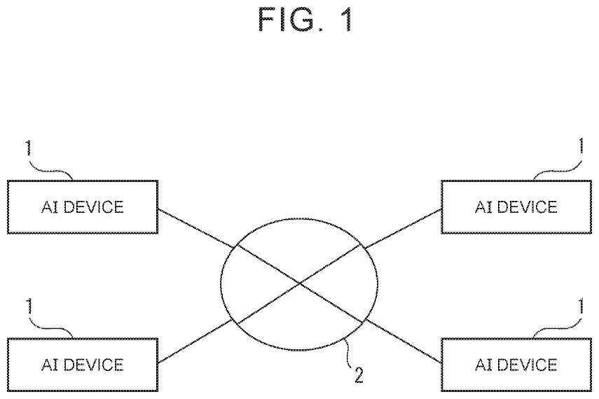

First, a first embodiment of the present disclosure will be described with reference to FIGS. 1 to 7.

FIG. 1 is a diagram schematically showing a plurality of AI devices 1 installed in a plurality of target areas. Each of the AI devices 1 is installed in a predetermined target area and manages a machine learning model used in the target area. The AI devices 1 can communicate with each other via a communication network 2 such as an Internet network or a carrier network. The AI device 1 is an example of a model management device.

The target area where the AI device 1 is installed has a predetermined range, and is a smart city defined as, for example, a “sustainable city or district where management (planning, maintenance, control, operation, etc.) is carried out to achieve overall optimization while utilizing new technologies such as Information and Communication Technology (ICT) in an effort to address various issues that occur in the city”. The target areas are located in different locations from each other, and are set, for example, in different regions (prefectures, states, etc.) in the same country or in different regions in different countries.

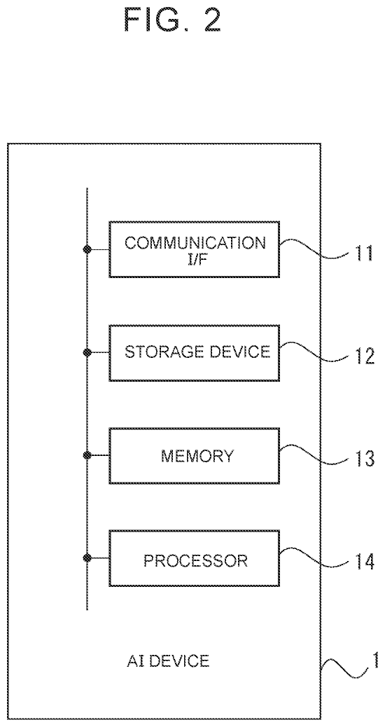

The AI devices 1 have similar configurations. FIG. 2 is a diagram schematically showing the configuration of the AI device 1 of FIG. 1. The AI device 1 includes a communication interface 11, a storage device 12, a memory 13, and a processor 14. The communication interface 11, the storage device 12, and the memory 13 are connected to the processor 14 via signal lines. The AI device 1 may further include an input device such as a keyboard and a mouse, an output device such as a display, and the like. Further, the AI device 1 may be composed of a plurality of computers.

The communication interface 11 has an interface circuit for connecting the AI device 1 to the communication network 2. The AI device 1 is connected to the communication network 2 via the communication interface 11 and communicates with the outside of the AI device 1 (for example, the outside of the target area where the AI device 1 is installed) via the communication network 2. The communication interface 11 is an example of a communication unit of the AI device 1. The AI device 1 may include a communication module capable of communicating with the radio base station and may be connected to the communication network 2 via the radio base station. That is, the AI device 1 is connected to the communication network 2 by wire or wirelessly.

The storage device 12 includes, for example, a hard disk drive (HDD), a solid state drive (SDD) or an optical recording medium, and an access device thereof. The storage device 12 stores various data including, for example, a computer program for the processor 14 to execute various processes. The storage device 12 is an example of a storage unit of the AI device 1.

The memory 13 has a non-volatile semiconductor memory (for example, random access memory (RAM)). The memory 13 temporarily stores various data and the like used when various processes are executed by the processor 14, for example. The memory 13 is another example of the storage unit of the AI device 1.

The processor 14 has one or a plurality of central processing units (CPUs) and peripheral circuits thereof, and executes various processes. The processor 14 may further have other arithmetic circuits such as a logical operation unit, a numerical operation unit, or a graphic processing unit.

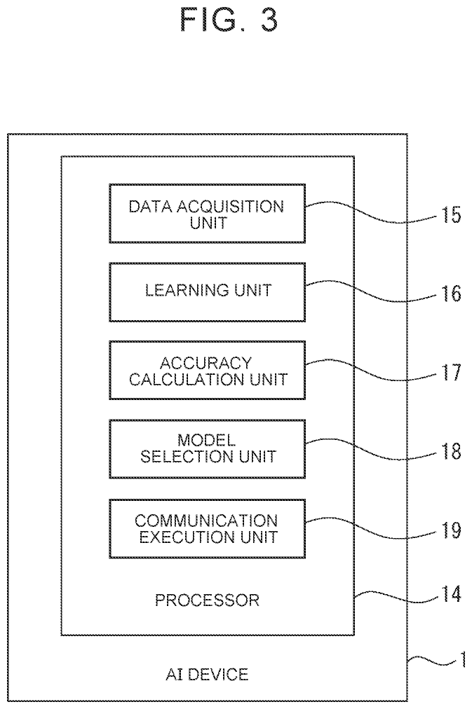

FIG. 3 is a functional block diagram of the processor 14 of the AI device 1. In the present embodiment, the processor 14 includes a data acquisition unit 15, a learning unit 16, an accuracy calculation unit 17, a model selection unit 18, and a communication execution unit 19. The data acquisition unit 15, the learning unit 16, the accuracy calculation unit 17, the model selection unit 18, and the communication execution unit 19 are functional modules that are realized when the processor 14 of the AI device 1 executes the computer program stored in the storage device 12 of the AI device 1. It should be noted that each of these functional modules may be realized by a dedicated arithmetic circuit provided in the processor 14.

The data acquisition unit 15 acquires data in the target area where the AI device 1 is installed. The learning unit 16 learns a machine learning model. The accuracy calculation unit 17 calculates the accuracy of the machine learning model. The model selection unit 18 selects a machine learning model to be used in the target area where the AI device 1 is installed. The communication execution unit 19 communicates with other AI devices 1 installed in other target areas, via the communication network 2.

The machine learning model managed by the AI device 1 outputs at least one output parameter from a plurality of input parameters. That is, the AI device 1 causes the machine learning model to output at least one output parameter by inputting a plurality of input parameters to the machine learning model. In learning of such a machine learning model, training data (teacher data) consisting of a combination of measured values of a plurality of input parameters and measured values (correct answer data) of at least one output parameter corresponding to these measured values is used.

The data acquisition unit 15 receives data from a sensor or the like provided in the target area, and creates training data to be used for learning of the machine learning model. Specifically, the data acquisition unit 15 extracts the measured values of a plurality of input parameters and the measured values of at least one output parameter corresponding to these measured values from the acquired data, and combines the measured values of the input parameters and the measured values of the output parameters to create the training data. The training data created by the data acquisition unit 15 is stored in the storage device 12. The training data may be created by a person such as an operator of the AI device 1.

The learning unit 16 learns a machine learning model using the training data created by the data acquisition unit 15. For example, when the machine learning model is a neural network model, the learning unit 16 uses a predetermined number of training data to repeatedly update the weight and the bias in the neural network model by a known backpropagation method so that the difference between the output values of the neural network model and the measured values of the output parameter becomes small. As a result, the neural network model is learned and the learned neural network model is generated. Information about the machine learning model generated by the learning unit 16 (for example, the weight, the bias, etc. of the neural network model) is stored in the storage device 12.

In the present embodiment, the data acquisition unit 15 acquires data at predetermined intervals and creates the training data using the acquired data. When the number of training data newly created by the data acquisition unit 15 reaches a predetermined number, the learning unit 16 learns the machine learning model using these training data.

However, even if the learning unit 16 repeatedly learns the machine learning model, the machine learning model may not match the prediction target and the accuracy of the machine learning model may not be sufficiently improved. Therefore, in the present embodiment, when the accuracy of the existing machine learning model is maintained to be less than a predetermined value, the learning unit 16 uses a machine learning model of a different type (algorithm) from the existing machine learning model to generate a new machine learning model.

As a result, if the accuracy of the machine learning model is improved, it may be possible to improve the accuracy of the machine learning model in other target areas by the same method. Therefore, in order to reduce the burden for improving the machine learning model in each target area, it is desirable to share the knowledge for improving the accuracy of the machine learning model among different target areas.

In view of this, in the present embodiment, when the machine learning model having an accuracy of a predetermined value or more is generated, the communication execution unit 19 transmits information about the machine learning model to another target area. Accordingly, when the machine learning model is used in a plurality of target areas, the accuracy of the machine learning model can be efficiently improved.

The following describes a case where the information about the machine learning model is transmitted from a first AI device 1a installed in a first target area to a second AI device 1b installed in a second target area. In this case, when the first machine learning model having an accuracy of a predetermined value or more is generated in the first target area, the communication execution unit 19 of the first AI device 1a transmits information about the first machine learning model to the second target area different from the first target area. When the first machine learning model having an accuracy of a predetermined value or more is generated in the first target area, the communication execution unit 19 of the second AI device 1b receives the information about the first machine learning model. Accordingly, the accuracy of the machine learning model can be efficiently improved in the second target area by using the knowledge obtained in the first target area.

However, the correspondence between the input parameter and the output parameter does not completely match between the first target area and the second target area. The machine learning model with improved accuracy in the first target area is therefore not always effective in the second target area.

Thus, the learning unit 16 of the second AI device 1b relearns the first machine learning model using the data acquired in the second target area. This makes it possible to adapt the first machine learning model generated in the first target area to the characteristics of the second target area.

Further, the accuracy calculation unit 17 of the second AI device 1b calculates the accuracy of the first machine learning model using the data acquired in the second target area, and compares the accuracy of the first machine learning model with the accuracy of the existing machine learning model in the second target area. When the accuracy of the first machine learning model is higher than the accuracy of the existing machine learning model, the model selection unit 18 of the second AI device 1b changes the machine learning model to be used in the second target area to the first machine learning model, and when the accuracy of the first machine learning model is equal to or less than the accuracy of the existing machine learning model, the model selection unit 18 of the second AI device 1b does not change the machine learning model to be used in the second target area. This makes it possible to avoid using a machine learning model that is effective only in the first target area in the second target area.

Further, when the accuracy of the first machine learning model is equal to or less than the accuracy of the existing machine learning model, the communication execution unit 19 of the second AI device 1b transmits the result to the first target area. When the communication execution unit 19 of the first AI device 1a receives the result from the second target area, the communication execution unit 19 of the first AI device 1a stops transmitting the first machine learning model to the remaining target areas (for example, the third target area or the like). This makes it possible to avoid the machine learning model effective only in the first target area from being expanded to other target areas.

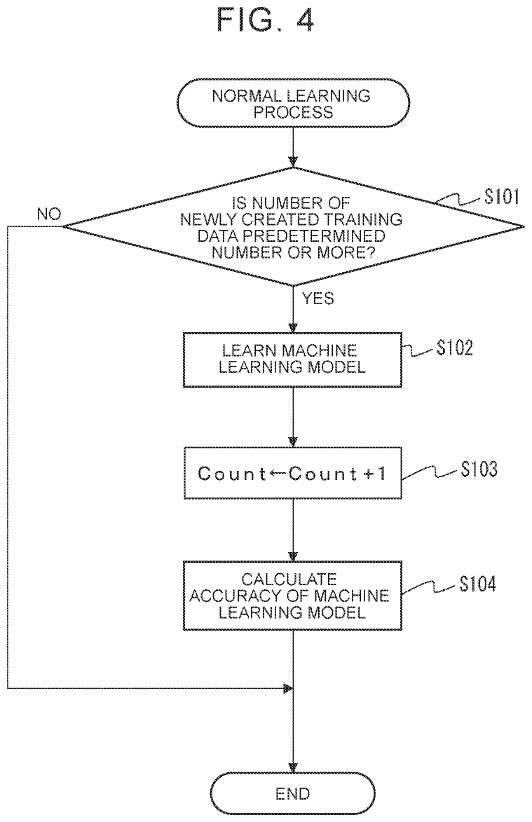

Hereinafter, the control flow for the above processes will be described with reference to the flowcharts of FIGS. 4 to 7. FIG. 4 is a flowchart showing a control routine of a normal learning process according to the first embodiment. This control routine is executed in each of the plurality of AI devices 1 installed in different target areas, and is repeatedly executed by the processor 14 of the AI device 1 at predetermined execution intervals.

First, in step S101, the learning unit 16 determines whether the number of training data newly created by the data acquisition unit 15 after the previous learning is a predetermined number or more. When it is determined that the number of training data is less than the predetermined number, this control routine ends. On the other hand, when it is determined that the number of training data is equal to or more than the predetermined number, the control routine proceeds to step S102.

In step S102, the learning unit 16 learns the machine learning model using the newly created training data. For example, when the machine learning model is a neural network model, the learning unit 16 updates predetermined parameters (weight and bias) of the machine learning model by a known backpropagation method.

Next, in step S103, the learning unit 16 updates the learning count Count by adding one to the learning count Count. The initial value of the learning count Count before the learning of the machine learning model is started is zero.

Next, in step S104, the accuracy calculation unit 17 calculates the accuracy of the machine learning model learned by the learning unit 16. For example, when the machine learning model is a neural network model, the accuracy calculation unit 17 calculates the accuracy of the machine learning model by a known verification method such as a holdout method or a cross-validation method. Test data used for verifying the accuracy of the machine learning model is created by a person such as an operator of the data acquisition unit 15 or the AI device 1 together with the training data and stored in the storage device 12. After step S104, this control routine ends.

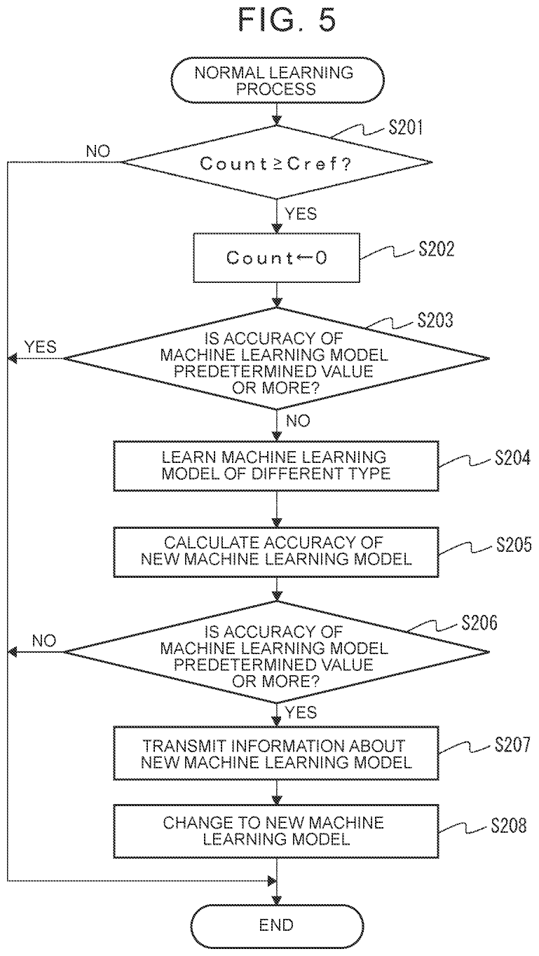

FIG. 5 is a flowchart showing a control routine of an accuracy improving process according to the first embodiment. This control routine is executed in each of the plurality of AI devices 1 installed in different target areas, and is repeatedly executed by the processor 14 of the AI device 1 at predetermined execution intervals.

First, in step S201, the learning unit 16 determines whether the learning count Count is equal to or greater than a predetermined number Cref. When it is determined that the learning count Count is less than the predetermined number Cref, this control routine ends. On the other hand, when it is determined that the learning count Count is equal to or greater than the predetermined number Cref, the control routine proceeds to step S202. In step S202, the learning unit 16 resets the learning count Count to zero.

Next, in step S203, the learning unit 16 determines whether the accuracy of the machine learning model calculated by the accuracy calculation unit 17 in step S104 of FIG. 4 is a predetermined value or more. When it is determined that the accuracy of the machine learning model is the predetermined value or more, this control routine is terminated and the existing machine learning model is continuously used. On the other hand, when it is determined that the accuracy of the machine learning model is less than the predetermined value, the control routine proceeds to step S204.

In step S204, the learning unit 16 learns a machine learning model of a type different from the existing machine learning model by using the training data stored in the storage device 12. That is, the learning unit 16 generates a new machine learning model using a type of machine learning model different from the existing machine learning model. For example, when the existing machine learning model is a neural network model, the learning unit 16 changes the machine learning model to be learned from the neural network model to a machine learning model other than the neural network model (for example, random forest, k-nearest neighbor method, support vector machine, etc.). Information necessary for learning a plurality of machine learning models (for example, a computer program for learning) is stored in the storage device 12 in advance, or is newly added to the storage device 12 by a person such as the operator of the AI device 1. The number and types of input parameters and output parameters of the existing machine learning model and the new machine learning model are the same, but the algorithms for outputting the output parameters from the input parameters are different between the two.

Next, in step S205, the accuracy calculation unit 17 calculates the accuracy of the new machine learning model generated by the learning unit 16 by using the test data stored in the storage device 12. Subsequently, in step S206, the communication execution unit 19 determines whether the accuracy of the new machine learning model is a predetermined value or more. When it is determined that the accuracy of the new machine learning model is less than the predetermined value, this control routine is terminated and the existing machine learning model is continuously used. On the other hand, when it is determined that the accuracy of the new machine learning model is the predetermined value or more, the control routine proceeds to step S207.

In step S207, the communication execution unit 19 transmits information about the new machine learning model (for example, the type and structure of the machine learning model, the values of the parameters obtained by learning, etc.) to at least one other target area (specifically, to the AI device 1 installed in the at least one other target area) via the communication network 2. For example, the communication execution unit 19 of the first AI device 1a transmits the information about the new machine learning model to the second target area (specifically, to the second AI device 1b installed in the second target area).

Next, in step S208, the model selection unit 18 changes the machine learning model to be used in the target area where the AI device 1 is installed from the existing machine learning model to the new machine learning model. As a result, the machine learning model to be learned in the control routine of the normal learning process of FIG. 4 is also changed to the new machine learning model. After step S208, this control routine ends.

Instead of steps S201 to S203, the learning unit 16 may determine whether the accuracy of the machine learning model is maintained to be less than a predetermined value for a predetermined period or longer.

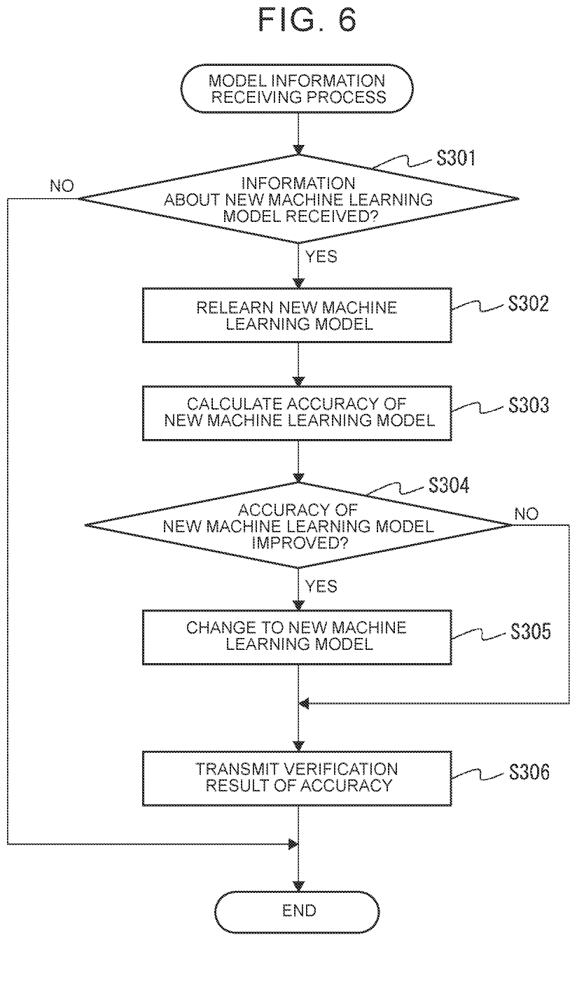

FIG. 6 is a flowchart showing a control routine of a model information receiving process according to the first embodiment. This control routine is executed in each of the plurality of AI devices 1 installed in different target areas, and is repeatedly executed by the processor 14 of the AI device 1 at predetermined execution intervals.

First, in step S301, the learning unit 16 determines whether the communication execution unit 19 has received information about the new machine learning model from another target area. When it is determined that information about the new machine learning model has not been received, this control routine ends. On the other hand, when it is determined that the information about the new machine learning model has been received, the control routine proceeds to step S302.

In step S302, the learning unit 16 relearns a new machine learning model using the training data stored in the storage device 12, that is, the data acquired in the target area where the AI device 1 is installed. The following describes a case of relearning when a new machine learning model is transmitted from the first AI device 1a installed in the first target area to the second AI device 1b installed in the second target area. In this case, the learning unit 16 of the second AI device 1b relearns the new machine learning model using the data acquired in the second target area.

For example, when the new machine learning model is a neural network model, the learning unit 16 further updates the weight in the new machine learning model using the data acquired in the second target area. At this time, only the weight of a part of an intermediate layer may be updated, and the weights of other intermediate layers may be fixed.

Typically, in the first target area and the second target area, the number and types of input parameters and output parameters when the new machine learning model is used are the same. However, some types of input parameters and output parameters when a new machine learning model is used may differ between the first target area and the second target area. That is, so-called transfer learning may be performed as relearning of a new machine learning model.

Next, in step S303, the accuracy calculation unit 17 calculates the accuracy of the new machine learning model relearned by the learning unit 16, using the test data stored in the storage device 12, that is, the data acquired in the target area where the AI device 1 is installed.

Subsequently, in step S304, the model selection unit 18 determines whether the accuracy of the new machine learning model is improved with respect to the existing machine learning model in the target area where the AI device 1 is installed. When it is determined that the accuracy of the new machine learning model is improved with respect to the existing machine learning model, the control routine proceeds to step S305.

In step S305, the model selection unit 18 changes the machine learning model to be used in the target area where the AI device 1 is installed from the existing machine learning model to the new machine learning model. For example, when the new machine learning model is transmitted from the first AI device 1a installed in the first target area to the second AI device 1b installed in the second target area, the model selection unit 18 of the second AI device 1b changes the machine learning model to be used in the second target area to the new machine learning model. After step S305, the control routine proceeds to step S306. On the other hand, when it is determined in step S304 that the accuracy of the new machine learning model is not improved with respect to the existing machine learning model, the control routine skips step S305 and proceeds to step S306.

In step S306, the communication execution unit 19 transmits, via the communication network 2, the verification result of the accuracy of the new machine learning model, specifically, the result of comparing the accuracy of the existing machine learning model with the accuracy of the new machine learning model, to the target area that has transmitted the new machine learning model. That is, the communication execution unit 19 notifies the target area that has transmitted the new machine learning model of whether the accuracy of the new machine learning model is improved with respect to the existing machine learning model in the target area that has received the new machine learning model. After step S306, this control routine ends.

Note that step S302 may be omitted. In this case, in step S303, the accuracy calculation unit 17 calculates the accuracy of the new machine learning model that has been reproduced based on the information about the new machine learning model, which has been transmitted from another target area, using the test data stored in the storage device 12, that is, the data acquired in the target area where the AI device 1 is installed.

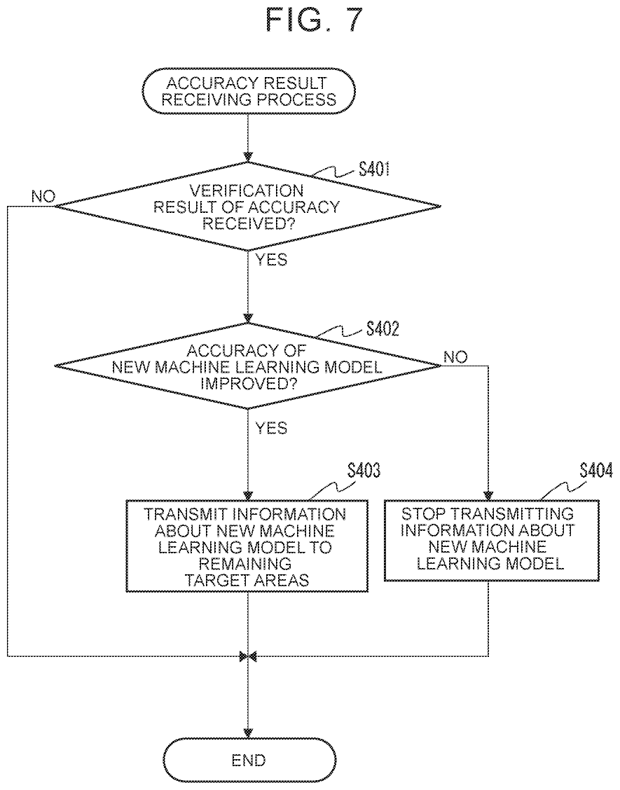

FIG. 7 is a flowchart showing a control routine of an accuracy result receiving process according to the first embodiment. This control routine is executed in each of the plurality of AI devices 1 installed in different target areas, and is repeatedly executed by the processor 14 of the AI device 1 at predetermined execution intervals.

First, in step S401, the communication execution unit 19 determines whether the verification result of the accuracy of the new machine learning model has been received from another target area. When it is determined that the verification result of the accuracy of the new machine learning model has not been received, this control routine ends. On the other hand, when it is determined that the verification result of the accuracy of the new machine learning model has been received, the control routine proceeds to step S402.

In step S402, the communication execution unit 19 determines whether the accuracy of the new machine learning model is improved with respect to the existing machine learning model in the other target area. When it is determined that the accuracy of the new machine learning model is improved in the other target area, the control routine proceeds to step S403. In step S403, the communication execution unit 19 transmits the information about the new machine learning model to the remaining target areas to which the new machine learning model has not yet been transmitted (specifically, to the AI device 1 installed in the remaining target areas). After step S403, this control routine ends.

On the other hand, when it is determined in step S402 that the accuracy of the new machine learning model is not improved in the other target area, the control routine proceeds to step S404. In step S404, the communication execution unit 19 stops transmitting the information about the new machine learning model to the remaining target areas to which the new machine learning model has not yet been transmitted. After step S404, this control routine ends.

When the communication execution unit 19 transmits the information about the new machine learning model to a plurality of target areas in step S207 of FIG. 5, instead of or in addition to steps S402 to S404 of FIG. 7, the communication execution unit 19 may transfer the verification result of the accuracy of the new machine learning model to the target area to which the new machine learning model has already been transmitted. For example, in the case where the communication execution unit 19 of the first AI device 1a receives a result that the accuracy of the first machine learning model is not improved with respect to the existing machine learning model in the second target area when the data acquired in the second target area has been used, the communication execution unit 19 of the first AI device 1a may transfer the result to another target area to which the new machine learning model has already been transmitted (for example, third target area, fourth target area, etc.). In this case, in the other target area that has received the result, the model selection unit 18 does not change the machine learning model to be used in the target area from the existing machine learning model to the new machine learning model. This makes it possible to avoid using a machine learning model with low versatility in many target areas.

Further, when the accuracy of the machine learning model calculated in step S104 of FIG. 4 reaches a predetermined value or more as a result of continuous learning of the machine learning model, the communication execution unit 19 may transmit the information about the machine learning model to another target area. In this case, the control routine for the accuracy improving process of FIG. 5 is omitted.

### Second Embodiment

The configuration and control of the AI device according to a second embodiment is basically the same as the configuration and control of the AI device according to the first embodiment, except for the points described below. Therefore, hereinafter, the second embodiment of the present disclosure will be described focusing on the parts different from the first embodiment.

In the first embodiment, when the accuracy of the new machine learning model generated by the learning unit 16 is a predetermined value or more, the machine learning model to be used in the target area is changed to the new machine learning model. However, when the versatility of the new machine learning model is low, the state where the accuracy of the new machine learning model is higher than the accuracy of the existing machine learning model is not always maintained for a long period of time.

Therefore, in the second embodiment, in a predetermined number or more of the target areas among the target areas to which the information about the new machine learning model has been transmitted, in the case where the accuracy of the new machine learning model is improved with respect to the existing machine learning model in each target area when the data acquired in each target area is used, the model selection unit 18 changes the machine learning model to be used in the target area where the new machine learning model has been generated to the new learning model. This makes it possible to reduce the defects caused by using the new machine learning model for a long period of time.

For example, in the case where the first machine learning model is transmitted from the first AI device 1a installed in the first target area to a plurality of other target areas, when the data acquired in each target area is used and the accuracy of the first machine learning model is improved with respect to the existing machine learning model in each target area in a predetermined number or more of target areas other than the first target area, the model selection unit 18 of the first AI device 1a changes the machine learning model to be used in the first target area to the first machine learning model.

Further, in the first embodiment, when the accuracy of the new machine learning model is improved with respect to the existing machine learning model, the machine learning model to be used in the target area to which the new machine learning model has been transmitted is changed to the new machine learning model. However, also in this case, the state where the accuracy of the new machine learning model is higher than the accuracy of the existing machine learning model is not always maintained for a long period of time.

Therefore, in the second embodiment, in the case where the accuracy of the new machine learning model is higher than the accuracy of the existing machine learning model, and the accuracy of the new machine learning model is improved with respect to the existing machine learning model in each target area when the data acquired in each target area is used in a predetermined number or more of the target areas among the other target areas to which the information about the new machine learning model has been transmitted, the model selection unit 18 changes the machine learning model to be used in the target area to which the new machine learning model has been transmitted to the new learning model. This makes it possible to reduce the defects caused by using the new machine learning model for a long period of time.

For example, in the case where the first machine learning model is transmitted from the first AI device 1a installed in the first target area to a plurality of other target areas including the second target area, when the accuracy of the first machine learning model is higher than the accuracy of the existing machine learning model in the second target area, and the data acquired in each target area is used and the accuracy of the first machine learning model is improved with respect to the existing machine learning model in each target area in a predetermined number or more of target areas other than the second target area, the model selection unit 18 of the second AI device 1b installed in the second target area changes the machine learning model to be used in the second target area to the first machine learning model.

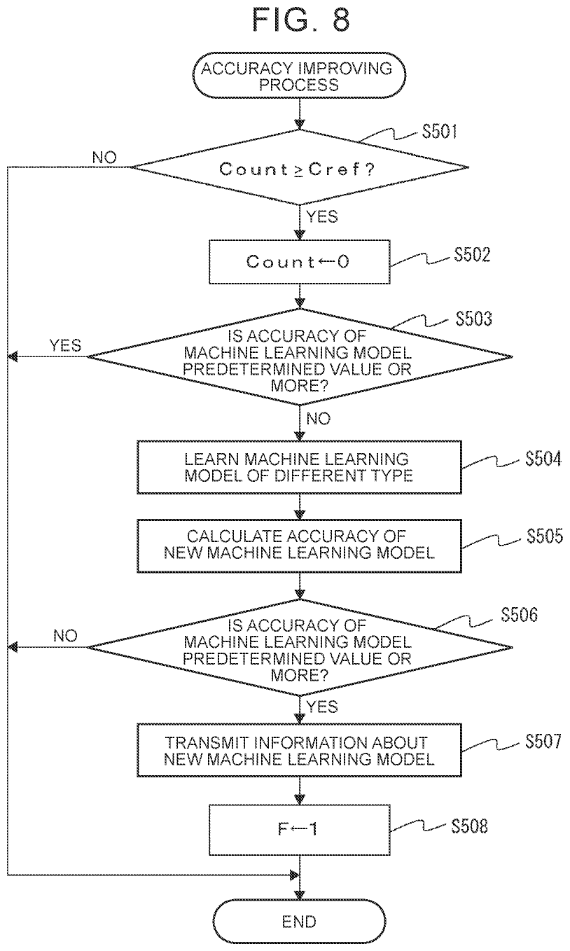

In the second embodiment, the control routine of the normal learning process of FIG. 4 is executed as in the first embodiment. However, in the second embodiment, the control routines of FIGS. 8 to 10 are executed instead of the control routines of FIGS. 5 to 7.

FIG. 8 is a flowchart showing a control routine of an accuracy improving process according to the second embodiment. This control routine is executed in each of the plurality of AI devices 1 installed in different target areas, and is repeatedly executed by the processor 14 of the AI device 1 at predetermined execution intervals.

Steps S501 to S507 are executed in the same manner as in steps S201 to S207 of FIG. 5. At this time, in step S507, the communication execution unit 19 transmits, via the communication network 2, information about the new machine learning model to a plurality of other target areas (specifically, to the AI devices 1 installed in the plurality of other target areas).

After step S507, in step S508, the model selection unit 18 sets the flag F to one instead of changing the machine learning model to be used in the target area to the new machine learning model. The initial value of the flag F is zero. After step S508, this control routine ends.

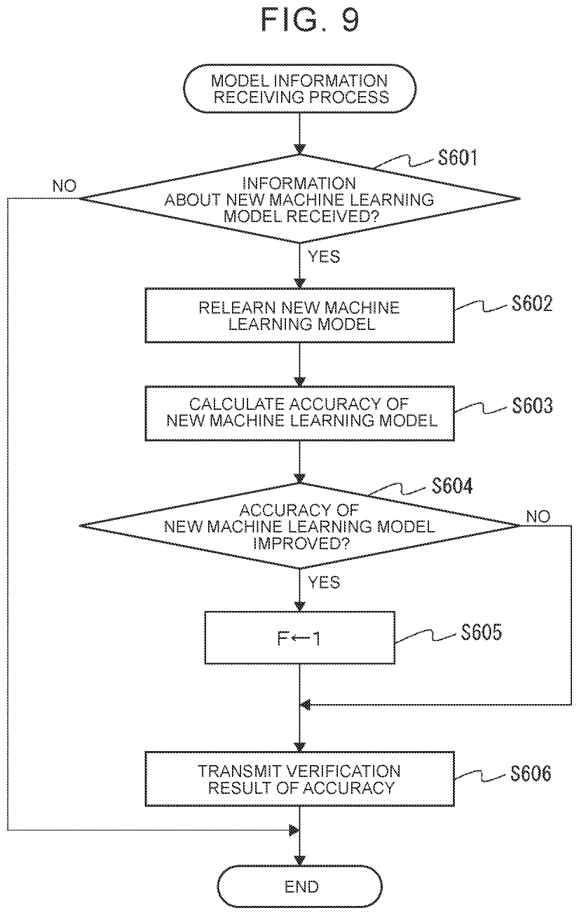

FIG. 9 is a flowchart showing a control routine of a model information receiving process according to the second embodiment. This control routine is executed in each of the plurality of AI devices 1 installed in different target areas, and is repeatedly executed by the processor 14 of the AI device 1 at predetermined execution intervals.

Steps S601 to S604 are executed in the same manner as in steps S301 to S304 of FIG. 6. When it is determined in step S604 that the accuracy of the new machine learning model is improved with respect to the existing machine learning model, the control routine proceeds to step S605. In step S605, the model selection unit 18 sets the flag F to one instead of changing the machine learning model to be used in the target area to the new machine learning model. The initial value of the flag F is zero. On the other hand, when it is determined in step S604 that the accuracy of the new machine learning model is not improved with respect to the existing machine learning model, the control routine skips step S605 and proceeds to step S606.

In step S606, the communication execution unit 19 transmits, via the communication network 2, the verification result of the accuracy of the new machine learning model to the target area to which the new machine learning model has been transmitted and to other target areas to which the new machine learning model has already been transmitted. After step S606, this control routine ends.

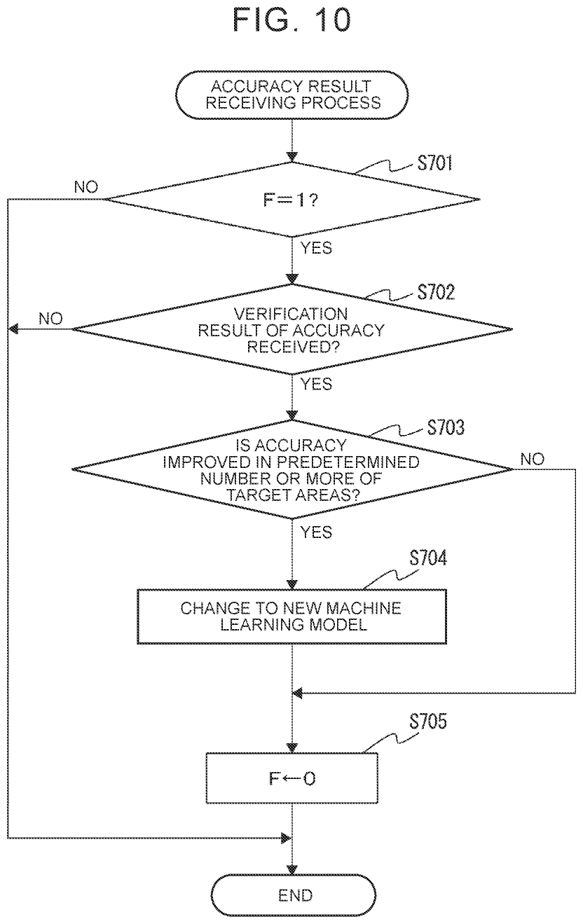

FIG. 10 is a flowchart showing a control routine of an accuracy result receiving process according to the second embodiment. This control routine is executed in each of the plurality of AI devices 1 installed in different target areas, and is repeatedly executed by the processor 14 of the AI device 1 at predetermined execution intervals.

First, in step S701, the model selection unit 18 determines whether the flag F is set to one. When it is determined that the flag F is set to zero, this control routine ends. On the other hand, when it is determined that the flag F is set to one, the control routine proceeds to step S702.

In step S702, the model selection unit 18 determines whether the communication execution unit 19 has received the verification result of the accuracy of the new machine learning model from the plurality of other target areas. For example, when this control routine is executed in the AI device 1 that has transmitted the information about the new machine learning model, it is determined whether the verification result of the accuracy of the new machine learning model is received from all the target areas to which the information about the new machine learning model has already been transmitted. On the other hand, when this control routine is executed in the AI device 1 that has received the information about the new machine learning model, it is determined whether the verification result of the accuracy of the new machine learning model is received from all the other target areas to which the information about the new machine learning model has already been transmitted.

When it is determined in step S702 that the communication execution unit 19 has not received the verification result of the accuracy of the new machine learning model from the plurality of other target areas, this control routine ends. On the other hand, when it is determined in step S702 that the communication execution unit 19 has received the verification result of the accuracy of the new machine learning model from the plurality of other target areas, the control routine proceeds to step S703. In step S703, the model selection unit 18 determines whether the accuracy of the new machine learning model is improved with respect to the existing machine learning model in a predetermined number or more of target areas.

The predetermined number may differ depending on the output parameter of the machine learning model to be changed. For example, when the output parameter is data related to human health, the predetermined number is increased as compared with the case where the output parameter is other than the data related to human health. This can suppress the reliability of predicting the data related to human health from being reduced by changes in the machine learning model. The data related to human health is, for example, the probability that a person has a predetermined disease, the human health level, and the like.

In step S703, when it is determined that the accuracy of the new machine learning model is improved in the predetermined number or more of the target areas, that is, when it is determined that the number of the target areas where the accuracy of the new machine learning model is improved is the predetermined number or more, the control routine proceeds to step S704. In step S704, the model selection unit 18 changes the machine learning model to be used in the target area where the AI device 1 is installed to the new machine learning model. After step S704, the control routine proceeds to step S705.

On the other hand, when it is determined in step S703 that the number of target areas where the accuracy of the new machine learning model is improved is less than the predetermined number, the control routine skips step S704 and proceeds to step S705. In this case, the existing machine learning model is continuously used without changing the machine learning model to be used in the target area to the new machine learning model.

In step S705, the model selection unit 18 resets the flag F to zero. After step S705, this control routine ends.

### Third Embodiment

The configuration and control of the AI device according to a third embodiment is basically the same as the configuration and control of the AI device according to the first embodiment, except for the points described below. Therefore, hereinafter, the third embodiment of the present disclosure will be described focusing on the parts different from the first embodiment.

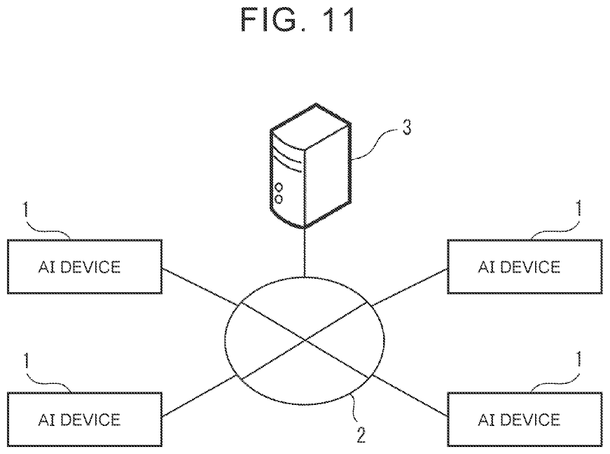

FIG. 11 is a diagram schematically showing a plurality of AI devices 1 installed in a plurality of target areas and a management server 3. The AI devices 1 can each communicate with the management server 3 via a communication network 2 such as an Internet network or a carrier network.

The management server 3 communicates with the plurality of AI devices 1 to indirectly manage the machine learning models used in the plurality of target areas where the plurality of AI devices 1 is installed. The management server 3 is another example of the model management device.

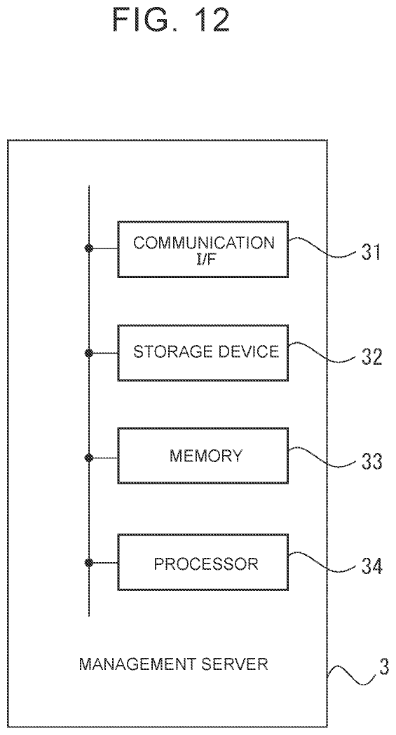

FIG. 12 is a diagram schematically showing the configuration of the management server 3 of FIG. 11. The management server 3 includes a communication interface 31, a storage device 32, a memory 33, and a processor 34. The communication interface 31, the storage device 32, and the memory 33 are connected to the processor 34 via signal lines. The management server 3 may further include an input device such as a keyboard and a mouse, an output device such as a display, and the like. Further, the management server 3 may be composed of a plurality of computers.

The communication interface 31 has an interface circuit for connecting the management server 3 to the communication network 2. The management server 3 is connected to the communication network 2 via the communication interface 31 and communicates with the outside of the management server 3 (the plurality of AI devices 1 and the like) via the communication network 2. The communication interface 31 is an example of a communication unit of the management server 3.

The storage device 32 includes, for example, an HDD, an SDD or an optical recording medium, and an access device thereof. The storage device 32 stores various data including, for example, information (identification information, etc.) of the plurality of AI devices 1, a computer program for the processor 34 to execute various processes, and the like. The storage device 32 is an example of a storage unit of the management server 3.

The memory 33 has a non-volatile semiconductor memory (for example, RAM). The memory 33 temporarily stores various data and the like used when various processes are executed by the processor 34, for example. The memory 33 is another example of the storage unit of the management server 3.

The processor 34 has one or a plurality of CPUs and peripheral circuits thereof, and executes various processes. The processor 34 may further have other arithmetic circuits such as a logical operation unit, a numerical operation unit, or a graphic processing unit.

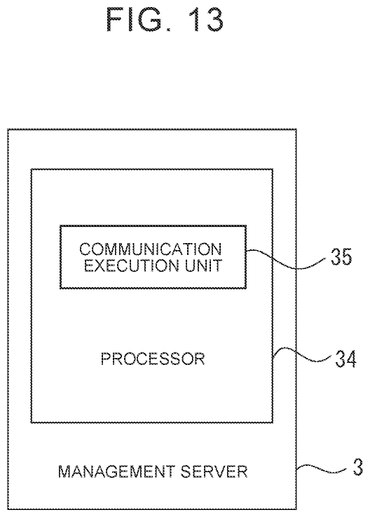

FIG. 13 is a functional block diagram of the processor 34 of the management server 3. As shown in FIG. 13, the processor 34 has a communication execution unit 35. The communication execution unit 35 is a functional module that is realized when the processor 34 of the management server 3 executes the computer program stored in the storage device 32 of the management server 3. The communication execution unit 35 may be realized by a dedicated arithmetic circuit provided in the processor 34. The communication execution unit 35 communicates with the plurality of AI devices 1 and exchanges information between a plurality of target areas where the plurality of AI devices 1 is installed.

Also in the third embodiment, the control routines of FIGS. 4 to 7 are executed as in the first embodiment. At this time, in step S207 of FIG. 5, information about the new machine learning model is transmitted from the AI device 1 to the management server 3, and the communication execution unit 35 of the management server 3 transmits the information to at least one other target area (specifically, to the AI device 1 installed in the at least one other target area) different from the target area of the information transmission source. For example, when information about a new machine learning model is transmitted from the first AI device 1a to the management server 3, the communication execution unit 35 of the management server 3 transmits the information to the second target area (specifically, to the second AI device 1b installed in the second target area).

Further, in the third embodiment, the verification result of the accuracy of the new machine learning model is transmitted from the AI device 1 to the management server 3 in step S306 of FIG. 6, and the control routine of the accuracy result receiving process of FIG. 7 is executed by the processor 34 of the management server 3. That is, upon receiving the result that the accuracy of the new machine learning model is improved with respect to the existing machine learning model, the communication execution unit 35 of the management server 3 transmits information about the new machine learning model to the remaining target areas, whereas upon receiving the result that the accuracy of the new machine learning model is not improved with respect to the existing machine learning model, the communication execution unit 35 of the management server 3 stops transmitting the information about the new machine learning model to the remaining target areas. Further, the communication execution unit 35 of the management server 3 may transfer the verification result of the accuracy of the new machine learning model to another target area to which the new machine learning model has already been transmitted.

Although the preferred embodiments of the present disclosure have been described above, the present disclosure is not limited to these embodiments, and various modifications and alterations can be made within the scope of the claims.

What is claimed is:

1. A model management device comprising a communication execution unit that transmits, when a first machine learning model having an accuracy of a predetermined value or more is generated in a first target area, information about the first machine learning model to at least one target area different from the first target area.

2. The model management device according to claim 1, wherein
the at least one target area includes a second target area, and
in a case where the communication execution unit receives a result that an accuracy of the first machine learning model is not improved with respect to an existing machine learning model in the second target area when data acquired in the second target area is used, the communication execution unit stops transmitting the information about the first machine learning model to remaining target areas.

3. The model management device according to claim 1, wherein
the at least one target area includes a second target area, and
in a case where the communication execution unit receives a result that an accuracy of the first machine learning model is not improved with respect to an existing machine learning model in the second target area when data acquired in the second target area is used, the communication execution unit transfers the result to the at least one target area other than the second target area.

4. The model management device according to claim 1, wherein the first machine learning model is generated using a different kind of a machine learning model from an existing machine learning model in the first target area.

5. The model management device according to claim 1, further comprising a model selection unit that is installed in the first target area and that selects a machine learning model to be used in the first target area, wherein
the first machine learning model is generated using a different kind of a machine learning model from an existing machine learning model in the first target area, and
when data acquired in each target area is used and an accuracy of the first machine learning model is improved with respect to an existing machine learning model in each target area in a predetermined number or more of target areas other than the first target area, the model selection unit changes the machine learning model to be used in the first target area to the first machine learning model.

6. A model management device installed in a second target area different from a first target area, the model management device comprising a communication execution unit that receives information about a first machine learning model when the first machine learning model having an accuracy of a predetermined value or more is generated in the first target area.

7. The model management device according to claim 6, further comprising a learning unit for relearning the first machine learning model using data acquired in the second target area.

8. The model management device according to claim 6, further comprising:
a model selection unit that selects a machine learning model to be used in the second target area; and
an accuracy calculation unit that calculates the accuracy of the first machine learning model using data acquired in the second target area, wherein when the accuracy of the first machine learning model calculated by the accuracy calculation unit is higher than an accuracy of an existing machine learning model in the second target area, the model selection unit changes the machine learning model to be used in the second target area to the first machine learning model.

9. The model management device according to claim 6, further comprising:
a model selection unit that selects a machine learning model to be used in the second target area; and
an accuracy calculation unit that calculates the accuracy of the first machine learning model using data acquired in the second target area, wherein in a case where the accuracy of the first machine learning model calculated by the accuracy calculation unit is higher than an accuracy of an existing machine learning model in the second target area, and the accuracy of the first machine learning model is improved with respect to an existing machine learning model in each target area when data acquired in each target area is used in a predetermined number or more of target areas other than the second target area, the model selection unit changes the machine learning model to be used in the second target area to the first machine learning model.

10. The model management device according to claim 8, wherein when the accuracy of the first machine learning model calculated by the accuracy calculation unit is equal to or less than the accuracy of the existing machine learning model in the second target area, the communication execution unit transmits a result to the first target area.

11. The model management device according to claim 5, wherein the predetermined number differs depending on an output parameter of a machine learning model to be changed.

12. The model management device according to claim 11, wherein when the output parameter is data related to human health, the predetermined number is increased as compared with a case where the output parameter is other than the data related to human health.

13. A model management method comprising transmitting, when a first machine learning model having an accuracy of a predetermined value or more is generated in a first target area, information about the first machine learning model to at least one target area different from the first target area.
